(19) United States
(12) Patent Application Publication
(10) Pub. No.: US 2020/0169480 A1
(43) Pub. Date: May 28, 2020

(54) SETTING DEVICE, SYSTEM, AND SETTING METHOD FOR CLOUD SERVICE

(71) Applicant: HITACHI, LTD., Tokyo (JP)

(72) Inventor: Isao SHIMOKAWA, Tokyo (JP)

(73) Assignee: HITACHI, LTD., Tokyo (JP)

(21) Appl. No.: 16/566,324

(22) Filed: Sep. 10, 2019

(30) Foreign Application Priority Data
Nov. 27, 2018 (JP) 2018-221351

(51) Int. Cl. H04L 12/24; H04L 12/14

(52) U.S. Cl. CPC H04L 41/5051; H04L 12/1435; H04L 41/0681; H04L 41/5022

(57) ABSTRACT

A cloud service setting device and method are capable of suppressing wasteful expenditure of a cloud service for a period of time in the future and performing seamlessly setting switching to a best cloud service. A setting device for selecting an appropriate cloud service from a plurality of cloud services based on a user request and setting the selected cloud service, includes: a storage device storing a cost for functions and services for the plurality of cloud services and commands for setting the plurality of cloud services as cloud asset information; and a processing unit predicting a cost to occur in the future based on the stored cloud asset information and the user request, selects one cloud service based on the predicted cost and generates time and setting information including a setting command, and transmits the setting information to a relay device to be set according to the time information.

### BACKGROUND OF THE INVENTION

### 1. Field of the Invention

The present invention relates to a setting device, a system, and a setting method for performing various settings for using a cloud service.

### 2. Description of the Related Art

In a cloud service, resources that want to be used can be allocated when the resources want to be used. The cloud service introduces a pay-per-use system in which there is no expenditure when resources are not used. In the case of using a plurality of cloud services of other companies, each cloud service has a very complicated charging format, and even when the cloud service is used, there are many setting items such as CPU performance and storage capacity.

In particular, since the pay-per-use is used, the cost (expenditure) varies depending on a frequency of use, a data amount, the number of VMs, or the like. In addition, since the fee systems are different among the cloud services, it is very troublesome to compare the expenditures of each cloud service. Especially, in the system integration (SI) business which builds systems according to customer requirements, customer requests vary, and selection of the best-practice cloud service among a plurality of cloud services having different fee systems and rapid system construction are required to be performed.

As a technology for constructing a cloud system, there is JP 2017-142673 A. JP 2017-142673 A discloses a cloud resources selection device that collects usage status (a CPU usage rate, a memory usage rate, a storage usage rate, an operation time, or the like) of an application of an on-premise or a cloud, statistically processes characteristics of the application on the basis of the collected usage status, and changes a purchase pattern in a case where there is a change in resources of the cloud on the basis of results of the statistical process.

In JP 2017-142673 A, the cloud resources selection device collects and statistically processes the usage status of the application of the on-premises or the cloud and changes the purchase pattern in a case where there is a change in the resources of the cloud on the basis of the results of the statistical process. That is, statistical process and calculation are performed in real time, and by changing purchase pattern, the setting change of the cloud service is performed. In a case where the setting change of the cloud service is needed, since the system does not have the necessary functions to cope with the setting change in advance, it takes time to change the setting, and thus, there is a possibility that the cloud service temporarily stops.

In addition, in the technology of JP 2017-142673 A, it is not disclosed that, in the case of being applied to a system for switching a plurality of cloud services, a change in a fee system of the plurality of cloud services is taken into consideration for a plurality of years in order to prevent unnecessary expenditure.

In addition, since the timing of switching is not taken into consideration, there is a possibility that the cloud service temporarily stops when the cloud service is switched and, thus, the customer's degree of satisfaction is lowered.

### SUMMARY OF THE INVENTION

The present invention is to provide a cloud service setting device, a system, and a setting method capable of suppressing wasteful expenditure of a cloud service for a certain period in the future and seamlessly switching the setting to the best cloud service.

According to an aspect of the present invention, there is provided a setting device for selecting an appropriate cloud service from a plurality of cloud services on the basis of a user request and performing setting the selected cloud service, the setting device including: a storage device which stores a cost for functions and services for the plurality of cloud services and commands for setting the plurality of cloud services as cloud asset information; and a processing unit which predicts a cost to occur in the future on the basis of the cloud asset information stored in the storage device and the user request, selects one cloud service from the plurality of cloud services on the basis of the predicted cost and generates time information to be selected and setting information including a setting command for the selected cloud service, and transmits the setting information to a relay device to be set according to the time information.

According to the present invention, by holding a plurality of necessary settings in advance, it is possible to select and use an optimal cloud service from a plurality of cloud services in the future.

In addition, since setting change of the cloud service is executed in consideration of a usage status of a system, the cloud service can be used seamlessly without service stoppage.

### BRIEF DESCRIPTION OF THE DRAWINGS

FIG. 1 is a system configuration diagram;

FIG. 2 is a diagram illustrating operations of a kitting device;

FIG. 3 is a diagram illustrating operations of a cloud adapter;

FIG. 4 is a block diagram of an interior of the cloud adapter;

FIG. 5 is a block diagram of an interior of the cloud adapter and the kitting device;

FIG. 6 is a diagram illustrating a GUI for inputting various parameters required by the kitting device;

FIG. 7 is a diagram illustrating a past user request (data amount, number of VMs, accumulation amount, or the like);

FIG. 8 is a diagram illustrating a cloud asset DB;

FIG. 9 is a diagram illustrating a history data DB;

FIG. 10 is a diagram illustrating a prediction result obtained from the past user request (data amount, number of VMs, accumulation amount, and the like);

FIG. 11 is a diagram illustrating future expenditure calculated from the prediction result obtained from the past user request (data amount, number of VMs, accumulation amount, or the like);

FIG. 12 is a diagram illustrating a trend of the future expenditure calculated from the prediction result obtained from the past user request (data amount, number of VMs, accumulation amount, or the like);

FIG. 13 is a diagram illustrating one function of a setting information unit;

FIG. 14 is a flowchart illustrating a series of operations of the kitting device;

FIG. 15 is a diagram illustrating control performed by the kitting device for a plurality of cloud adapters;

FIG. 16 is a diagram illustrating a trend of a data amount transmitted from an OT-hub;

FIG. 17 is a flowchart illustrating a series of operations of the kitting control unit;

FIG. 18 is a diagram illustrating a GUI of the kitting device; and

FIG. 19 is a hardware configuration diagram of the kitting device.

### DETAILED DESCRIPTION OF THE PREFERRED EMBODIMENTS

Hereinafter, modes (hereinafter referred to as “embodiments”) for carrying out the present invention will be described with reference to the drawings.

Hereinafter, embodiments of the present invention will be described with reference to the drawings. In the accompanying drawings, in some cases, the same components are denoted by the same reference numerals.

In addition, in the embodiments of the present invention, as described later, the embodiments may be implemented by software running on a general-purpose computer, may be implemented by dedicated hardware, or may be implemented by a combination of software and hardware.

Hereinafter, in some cases, each process in an embodiment of the present invention may be described with a “program” as a subject (operation subject). Since the program stored in the memory performs processes determined by being executed by the processor, the actual processing subject is the processor, but in some cases, the program may be described as the subject for description. A portion or all of the program may be realized by dedicated hardware or may be modularized. Various programs may be installed in each computer by a program distribution server or a storage medium.

In the following description, various types of information will be described in a table format, but information for management may not necessarily be expressed in a data structure by using a table.

The cloud service setting device, the system, and the setting method disclosed in the present embodiment relates to a technology for selecting an optimal cloud service from the plurality of cloud services in the future by acquiring fee systems of a plurality of cloud services in advance or in real time, comparing the fee systems with a plurality of services on the basis of changes in the data amount, the number of VMs, and the like of the system, selecting the optimal cloud service by predicting the fees in the future, and holding a plurality of necessary settings in advance.

In addition, the cloud service setting device, the system, and the setting method disclosed in present embodiment relate to technology that the cloud service can be seamlessly used without service stoppage since the setting change of the cloud service is executed in consideration of the use status of the system.

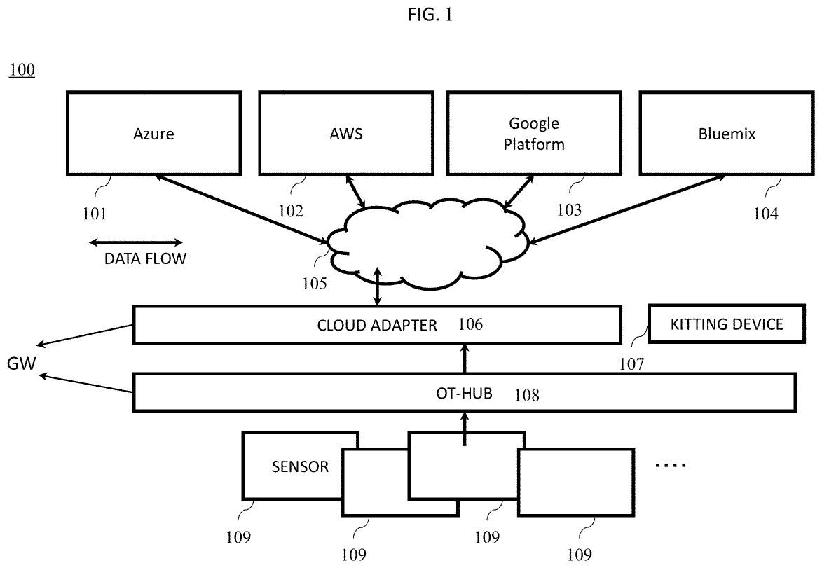

A system configuration diagram in the present embodiment is illustrated in FIG. 1. FIG. 1 is a diagram illustrating a system 100 that transfers data transmitted from a plurality of sensors to a plurality of clouds via an operational technology (OT)-hub 108 and a cloud adapter 106.

The system 100 includes a plurality of sensors 109, an OT-hub 108, a kitting concierge (kitting device) 107, a cloud adapter 106, a network 105, an Azure (registered trademark) 101, an AWS (registered trademark) 102, a GCP (registered trademark) 103, and a Bluemix (registered trademark) 104 and transfers sensor data from the plurality of sensors to each cloud service such as the Azure 101, the AWS 102, the GCP 103, and the Bluemix 104 via the OT-hub 108, the cloud adapter 106, and the network 105. In this system, the OT-hub 108 manages a plurality of sensors 109 in order to monitor the status at various sites, and the sensors transmit data to the OT-hub 108 by using wireless and wired communication means. The OT-hub 108 transfers the data from the sensor 109 to the cloud adapter 106. The cloud adapter 106 transfers the data to each cloud service via the network.

These data are provided to customers through public clouds such as the Azure 101 and the AWS 102. Each of the OT-hub 108 and the cloud adapter 106 can be regarded as a relay device (Gate Way: GW) for transferring the data to the cloud service in the system.

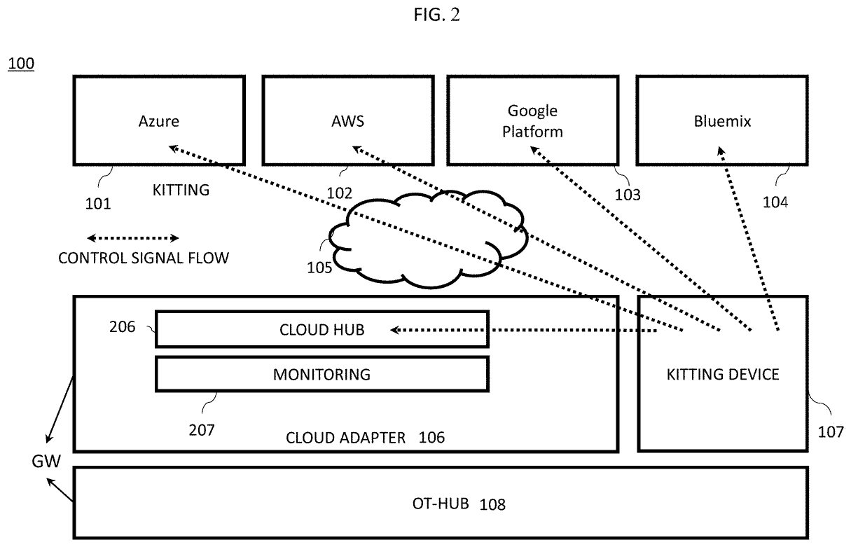

FIG. 2 is a diagram illustrating operations of the kitting device 107 of the present embodiment. Kitting is a setting operation generally performed when a personal computer or a mobile terminal is introduced. Herein, the kitting denotes a setting operation of a relay device or a public cloud for each public cloud such as the Azure 101 and the AWS 102. Therefore, the kitting device can be called a relay device or a public cloud setting device.

The cloud adapter 106 has two main functions, that is, monitoring 207 and a cloud hub 206 as functions. The cloud hub 206 switches the data received by the cloud adapter 106 to each cloud service and transfers the data. In order to use each of the cloud services 101, 102, 103, and 104, the kitting device 107 performs various settings for transmitting the sensor data from the sensor 109 to each of the cloud services 101, 102, 103, and 104 via the relay devices (the OT-hub 108 and the cloud adapter 106). The various settings include settings for each of the cloud services 101, 102, 103, and 104 and settings of arrangement (installation) of the adapter corresponding to each of the cloud services with respect to the cloud adapter 106 and various parameters by setting commands. The monitoring 207 performs monitoring the data (for example, the sensor data) transferred from the OT-hub 108. The cloud hub 206 transfers the data transmitted from the OT-hub 108 to each cloud service on the basis of a routing table.

There are a plurality of the cloud services, but the Azure 101 is used as a representative example. In the Azure, in order to control various settings for functions and services from another remote server, various setting parameters are converted to a JavaScript object notation (Json) format, and the setting parameter converted to the Json format are transmitted to the Azure with representational state transfer (Rest).

For example, as the parameters to be set, resourceName, resourceGroupName, subscriptionId, and the like are exemplified. In the case of using the Azure, there is a need to make a subscription contract (free evaluation version, pay-per-use plan, or the like) with Microsoft. After the contract, subscriptionId is allocated, and at the time of using the Azure, confirmation is required as one of the authentication keys.

As a function in the Azure, an IoT-Hub function is provided. However, if the IoT-Hub function wants to be used, there is a need to define the parameters of iotHubDescription as a parameter and transmit the parameter to the Azure.

The IoT-Hub function of the Azure can establish bi-directional communication with billions of IoT devices and can ensure sufficient security of a connected device, grasp the status of the device, and transfer to other Azure services such as Stream Analytics without writing code.

In addition, commands and notifications can be transmitted to each device in a highly reliable manner. After that, by using PowerBI of the Azure from Stream Anaylytics, it is possible to graphically display the trend of data in real time, and in the case of an environment that can connect to Azure, the data can be browsed by using the PowerBI at any location.

In addition, the hitting device 107 arranges an adapter for each cloud service in the cloud adapter with respect to the cloud adapter 106. Each adapter transfers the data received by the cloud adapter 106 to each cloud service. The OT-hub 108 transmits the data to the cloud adapter 106.

As described above, depending on which public cloud is used, in other words, depending on which public cloud the sensor data received from the sensor 109 received by the OT-hub 108 is transferred to, the hitting device 107 performs setting of the cloud adapter 106 and each public cloud.

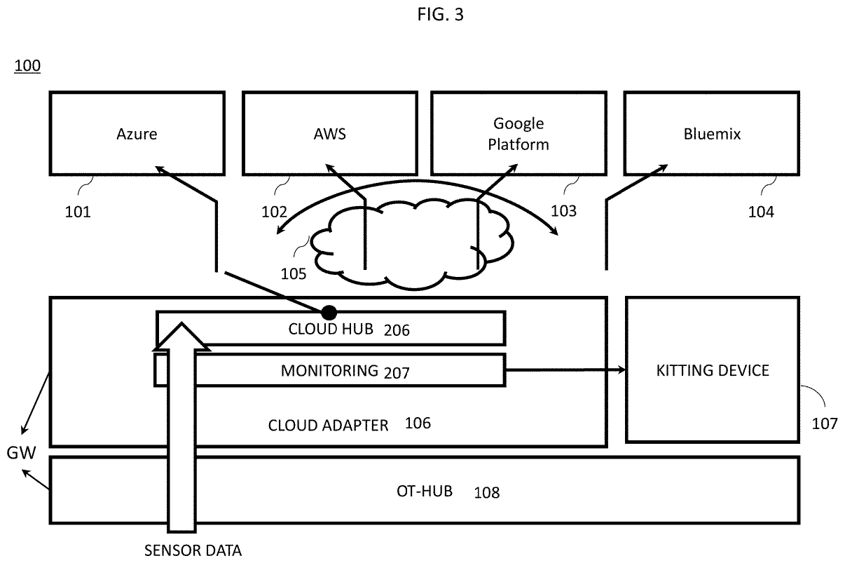

FIG. 3 is a diagram illustrating operations of the cloud adapter 106 in the present embodiment. The cloud adapter 106 has functions of the cloud hub 206 and the monitoring 207. The monitoring function performs monitoring the data (for example, sensor data) transferred from the OT-hub 108, and the cloud hub 206 transfers the data transmitted from the OT-hub 108 to each of the cloud services 101, 102, 103, and 104 on the basis of the routing table.

The routing table defines which sensor information is transferred to which cloud service. The contents of the routing table can be dynamically changed from the kitting device 107. By controlling the routing table, the switching of the cloud service is controlled, and the cloud service for transferring the data is determined.

The monitoring 207 performs the monitoring of the data received by the cloud adapter and performs analysis. In addition, the analysis result and the alert are transmitted to the kitting device 107. The kitting device 107 controls the settings (kitting control) of the cloud adapter 106 and each public cloud, particularly, the setting timing on the basis of the received alert and analysis parameters.

Accordingly, since the setting change of the cloud service is executed in consideration of the usage status of the system, the cloud service can be used seamlessly without service stoppage.

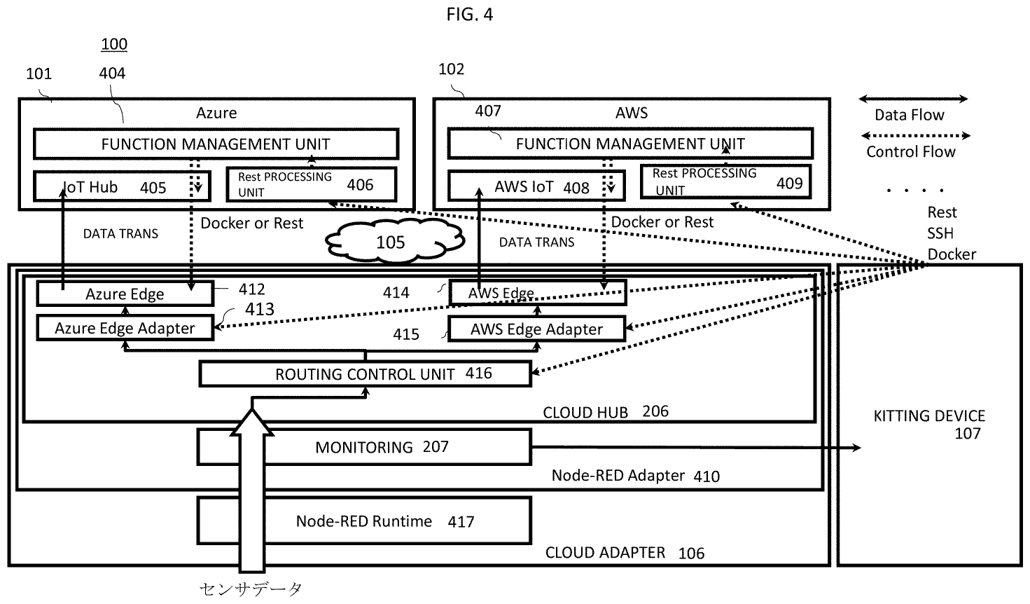

FIG. 4 is a configuration block diagram of the interior of the cloud adapter 106 in the present embodiment. The cloud adapter 106 has the functions of the cloud hub 206 and the monitoring 207 as described with reference to FIG. 3. A Node-RED runtime 417 is provided for programming these functions from a remote server. It is possible to describe and define operations in a Node-RED (not illustrated) of a master which manages a plurality of Node-REDs.

The Node-RED is a graphical programming tool which can perform programming by arranging and connecting abstract blocks on a screen. In order to perform the programming from the Node-RED runtime 417, it is necessary to provide an adapter for the Node-RED, and thus, the cloud adapter 106 includes a Node-RED adapter 410 as a function.

Two functions of the cloud hub 206 and the monitoring 207 are defined within the Node-RED adapter 410 by programming. The cloud hub 206 in the cloud adapter 106 includes an adapter having a function for transferring data of a routing control unit 416 and an Azure Edge adapter 413, an AWS Edge adapter 415, and the like corresponding to each cloud service. These adapters correspond to the respective cloud services and function as a GCP Edge adapter or a Bluemix Edge adapter in other cloud services.

In addition, the monitoring 207 also performs monitoring of the data transferred from the OT-hub 108 in real time and transmits an alert or analyzed information to the kitting device 107 on the basis of the monitoring result. For example, an alert is transmitted in a case where there is a lot of sensor data transmission or in a case where a burst occurs. This is because the setting change of the cloud service is executed in consideration of the usage status of the system, so that the cloud service can be switched seamlessly without service stoppage.

The kitting device 107 downloads the Azure Edge adapter 413 and the AWS Edge adapter 415 corresponding to the respective cloud services in the cloud hub 206 by using a communication method such as secure shell (SSH) or Docker. That is, the Azure Edge adapter 413 and the AWS Edge adapter 415 are customized in the kitting device 107 such that the data transferred from the OT-hub 108 can be transferred to the Azure 101 and AWS 102.

The cloud hub 206 updates the Azure Edge adapter 413 and the AWS Edge adapter 415 downloaded from the kitting device 107. The kitting device 107 transmits the setting parameter to the routing control unit 416 by using Rest or transmission control protocol (TCP) communication or the like in order to create a routing table.

The routing control unit 416 creates a routing table for routing (for example, transmitting to S3 of the AWS) data on the basis of the received setting parameter and transfers the received data to each adapter corresponding to each cloud service.

In addition, the kitting device 107 transmits the setting parameter to the Azure 101 and the AWS 102 by using Rest. Each cloud service such as Azure and AWS receives the Rest transmitted from the kitting device 107 by the Rest processing units (406 and 409), analyzes the setting parameter, and transmits the setting parameter to the function management units 404 and 407. The function management unit arranges functions of the Azure or the AWS such as an IOT-Hub 405 and an AWS IoT 408 in the Azure or the AWS by using the received setting parameter. In addition, the function management unit downloads an Azure Edge, an AWS Edge, and the like into the cloud hub 206 by using a Docker.

In this manner, the kitting device 107 transmits parameters for creating the routing table to the routing control unit 416, transmits adapters required for using each cloud service to the cloud hub 206, and transmits parameters for setting a function for receiving the data transmitted from the cloud hub 206 to each cloud service.

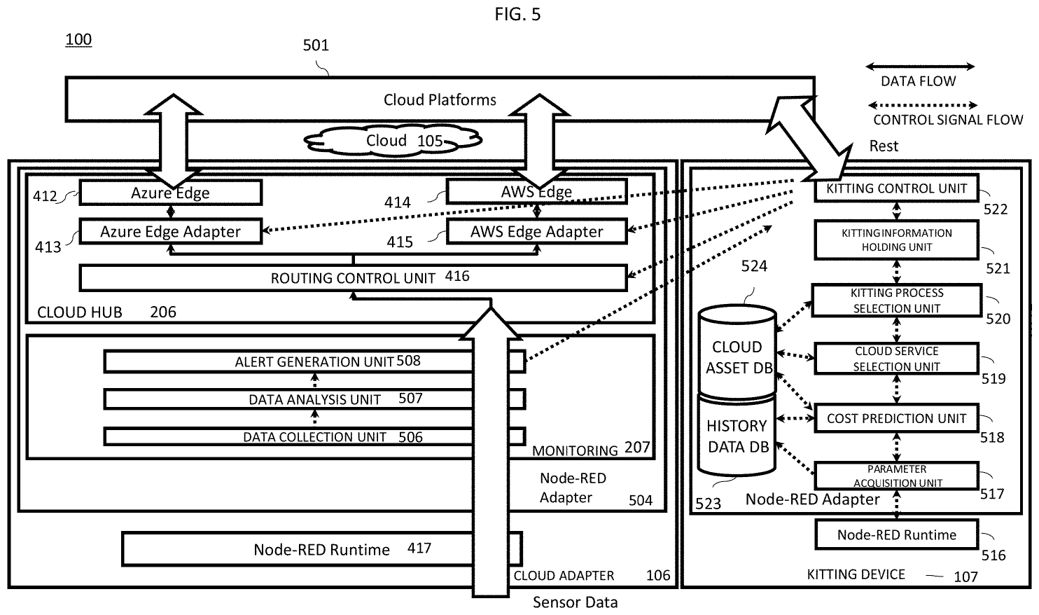

FIG. 5 is a detailed configuration block diagram of the interior of the cloud adapter 106 and the kitting device 107 in the present embodiment. The monitoring 207 of the cloud adapter 106 includes a data collection unit 506, a data analysis unit 507, and an alert generation unit 508.

The data collection unit 506 collects the data such as the sensor data received by the cloud adapter 106 in real time. The data analysis unit 507 analyzes the data collected by the data collection unit 506. As the analysis, for example, a statistical analysis is performed as to what data such as the type and parameters of the sensor data is transmitted, what degree of data amount is transmitted, and what degree of standard deviation is.

The characteristics of the received data are evaluated by performing the statistical analysis. For example, when the standard deviation is close to substantially 0, it can be evaluated that there is no sudden change in the data amount (although this evaluation may not always be a correct evaluation). That is, it can be evaluated that a burst hardly occurs as a simple evaluation.

The degree of burst can also be estimated from a ratio between the average data amount and the standard deviation. For example, when the average data amount is 80 MB and the standard deviation is 10 MB, it can be predicted that a burst of about ⅛ of the average occurs. If the average data amount is 40 MB and the standard deviation is 10 MB, it can be predicted that a burst of about ¼ of the average occurs. Even if the standard deviation is the same between the average of 80 MB and the average of 40 MB, it can be evaluated simply that the fluctuation of the case of the average of 40 MB is twice larger.

Since a system with a large fluctuation is more likely to be unstable, it is considered that a system with a large ratio may switch the cloud service, that is, postpone the kitting control. That is, at the timing when the fluctuation is large, it is possible not to perform the setting change of the cloud adapter that is a relay device for each public cloud. For this reason, an alert including the analysis result is generated by the alert generation unit 508 on the basis of the analysis result, and the alert is transmitted to the kitting device 107.

The kitting device 107 also includes a Node-RED runtime 516 and can be programmed remotely. It is possible to define the operation with the Node-RED of the Master that manages a plurality of Node-REDS. In order to perform the programming from the Node-RED runtime, it is necessary to provide an adapter for the Node-RED, and thus, the kitting device has the Node-RED adapter as a function. Within the Node-RED adapter, the function of the kitting device 107 is defined by programming.

In the kitting device 107, a parameter acquisition unit 517 acquires various setting parameters from the Node-RED and stores the acquired parameters as a history data DB 523 in the storage device. The various setting parameters acquired from the Node-RED by the parameter acquisition unit 517 also include information on specifications requested by the user for the cloud service, for example, the data amount actually stored, the number of VMs to be created, the storage capacity defined as a storage device, and the like. The history data DB holds history information of the user requests. In addition, the storage device of the kitting device 107 includes a cloud asset DB 524. In the cloud asset DB 524, functions and services (assets) that can be used in each cloud service, costs for these functions and services, and commands required for setting are stored as cloud asset information.

A cost prediction unit 518 predicts the future charging status by polynomial approximation on the basis of the setting parameters acquired from the history data DB 523 by using the various parameters in the history data DB 523 and the cloud asset DB 524.

A cloud service selection unit 519 determines the cloud service to be selected in the future on the basis of the result predicted by the cost prediction unit 518.

A kitting process selection unit 520 generates commands for a plurality of cloud services selected in the future by using the cloud asset DB. For example, in a case where the IoT-hub of the Azure is to be used in the future, a format of an iot-hub_CreateorUpdate command is acquired from the cloud asset DB, the parameters defined in the format are set according to the customer request, and the command is generated.

For other cloud service functions, a command format is acquired from the cloud asset DB, parameters are set, and the command is generated. After that, the generated command is transmitted to a kitting information holding unit 521. The kitting information holding unit 521 stores the generated command in a queue and transmits the command to a kitting control unit 522 at an appropriate timing.

The kitting control unit 522 transmits the received command to each cloud service, the cloud hub 206, and the routing control unit 416 on the basis of the alert transmitted from the cloud adapter 106.

Accordingly, since the setting change of the cloud service is executed in consideration of the usage status of the system, the cloud service can be used seamlessly without service stoppage.

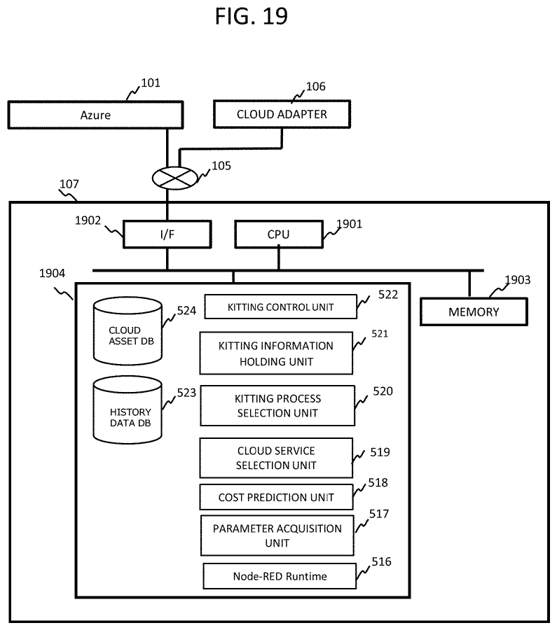

FIG. 19 illustrates a hardware configuration diagram of the kitting device 107. The kitting device 107 includes an interface 1902 that connects to the Azure 101 or the like that is a public cloud and the cloud adapter 106 which is a relay device via the network 105. A storage device 1904 configured with a hard disk, an SSD, or the like stores the cloud asset DB 524, the history data DB 523, and various programs. The various programs are Node-RED runtime 516, a parameter acquisition unit 517, a cost prediction unit 518, a cloud service selection unit 519, a kitting process selection unit 520, a kitting information holding unit 521, and a kitting control unit 522, and the description of operations of each program is the same as described with reference to FIG. 5. These programs are read into a memory 1903 and executed by a CPU 1901 which is a processing unit to realize each function. The storage device 1904, the interface 1902, the CPU 1901, and the memory 1903 are connected to each other so as to be able to transmit and receive data with each other, for example, via a bus.

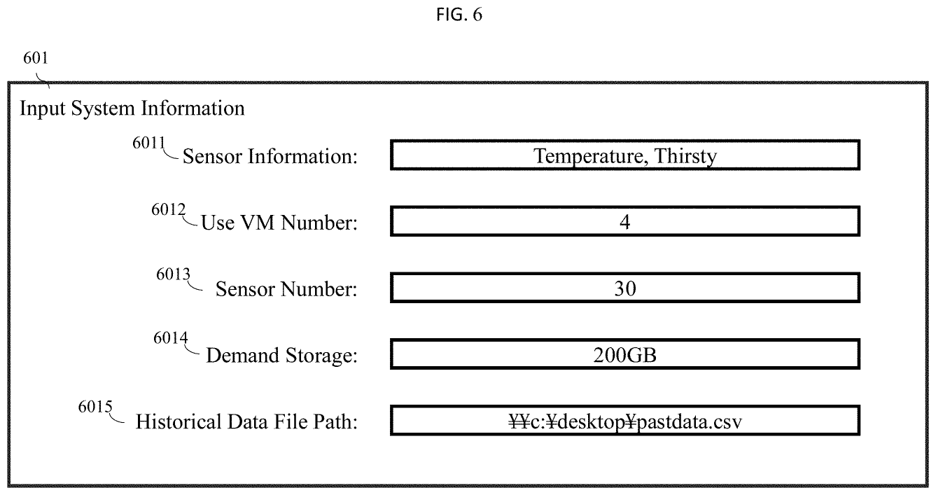

FIG. 6 is a diagram illustrating a graphical user interface (hereinafter referred to as GUI) 601 for inputting various parameters required by the kitting device 107 according to the present embodiment. As the parameters to be input this time, there are exemplified a sensor type 6011, the number of VMs used 6012, the number of sensors 6013, a storage capacity 6014 reserved for the cloud service, and a file path 6015 indicating the location of a file in which past user requests (data amount, number of VMs, or the like) are stored.

There are many parameters required for optimally performing the kitting, and it is necessary to add the parameters according to customer requirements. For example, besides the parameters exemplified herein, there are parameters such as a CPU usage rate, a memory usage rate, and a latency. In the system that the customer has or the system that the customer desires, in a case where there are Temperature (temperature) and Thirsty (humidity) as the type of sensor used or desired to be used, the temperature and humidity are described in the sensor type.

The kitting device 107 selects and determines the most appropriate cloud service from this information according to the conditions defined in advance for each cloud service such as whether to be stored in the Blob of the Azure or whether to be stored in the S3 of the AWS in consideration of the information importance, the cost, and the information amount.

The Blob of the Azure is not as durable as Eleven Nine guaranteed by the S3 of the AWS but the Blob has a capacity in units of exabyte and extremely high scalability, so that it is possible to store hundreds to billions of objects at the hot level, cool level, or archive level depending on the required data access frequency, and it is possible to preserve unstructured data such as images, videos, audios, and documents easily and with a high cost efficiency.

On the other hand, the S3 of the AWS is designed to provide durability called Eleven Nine to an object-type storage that can store and acquire any data amount from any one of website or mobile applications, intra-office applications, data from IoT sensors and devices and store data for millions of applications.

For this reason, as an example of conditions, temperature information is low in importance, so that the temperature information is stored in the Blob of the Azure; and a history and the like of CPU event is very important for debugging the system, so that the history of CPU event is stored in the S3 of the AWS.

In addition, with respect to the number of VMs, by estimating in advance how many VMs are to be used and, in the kitting device 107, by considering the cost, it is selectively determined whether the most appropriate cloud service for each cloud service is an Azure VM or a Google Platform VM according to according to the defined conditions (for example, a lowest price).

The kitting device 107 selects and determines the most appropriate cloud service among the cloud services from the information on the number of sensors in consideration of the cost and the information amount. In addition, the appropriate cloud service is selected and determined in consideration of the cost from the information on the storage capacity requested by the customer or the necessary storage capacity.

In addition, the kitting device 107 estimates the future from the past user requests or the history of resources required by the system to calculate the cost and selects and determines the cloud service with a low expenditure for the future.

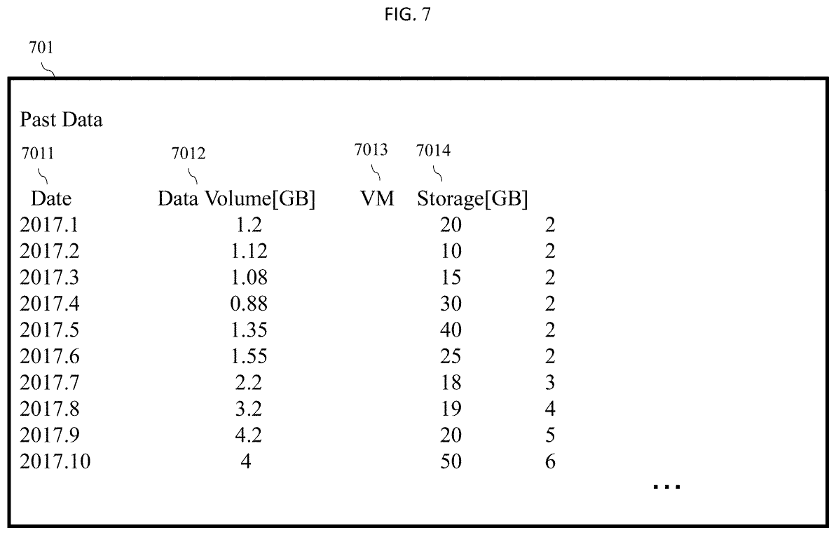

FIG. 7 is a diagram illustrating user requests (at least the data amount, the number of VMs, the storage capacity, or the like) to the cloud service in the present embodiment. In FIG. 7, as an example, the date 7011 and the data amount 7012 requested for the cloud service, or the data amount 7012 required for the system, the number of VMs 7013 requested or used for the cloud service, and the storage capacity 7014 requested or used for the cloud service for the date are illustrated.

Herein, in a case where this year is 2018, data of 2017 is illustrated as past data 701. If there are a lot of the past data, accurate future prediction is possible by a method such as regression. Such data is stored as a csv file and stored in the history data DB 523 of the kitting device 107.

The kitting device 107 performs future prediction and controls kitting on the basis of the data stored in the database. As the system data (parameters) required to use the cloud service, besides the system data defined herein, there are exemplified, for example, data such as a CPU usage rate, a memory usage rate, a latency, a network traffic, a processor idle time, a buffer cache amount, a swap amount, the number of abnormal Log messages, and the number of times of server accessing. However, all of these data are not necessarily required for constructing the system, but these data may be used according to the performance required for the system.

For example, as the information that can be inferred from the CPU usage rate, if the system requires a high amount of computation, the CPU usage rate is always high, so that it is necessary to select a VM with high CPU performance as the system. Similarly, with respect to the memory usage rate, if the memory use amount is high, it is necessary to select a VM with a high memory capacity. In the case of using the cloud services, servers are often located far away, and thus, the latency is an important parameter when connecting to the distant servers. In a case where the latency is high in the cloud service, the responsiveness of the system using the service becomes poor, and the real-time property disappears.

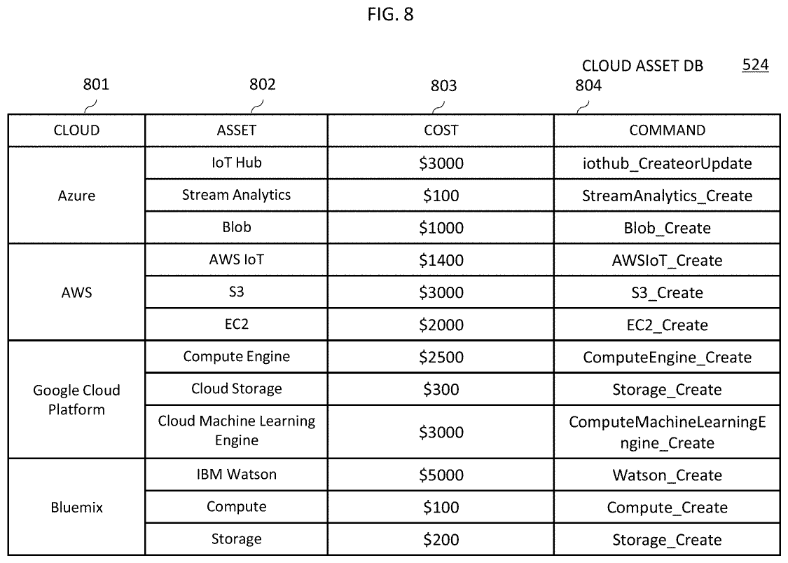

FIG. 8 is a diagram illustrating the cloud asset DB 524 in the present embodiment. The kitting device 107 includes the cloud asset DB 524 as a database, and functions and services (assets) 802 that can be used in each cloud service 801, costs 803 for those functions and services, and a command 804 required for settings are stored in a Json format or the like in the cloud asset DB in advance. New functions and services can be added later by external input.

For example, from FIG. 8, the Azure has an IOT-hub, a Stream Analytics, and a Blob as assets, that is, functions and services and the prices (costs) are illustrated to be $3000, $100, and $1000. These pieces of information are only examples and are different from actual prices. In addition, as the commands required to set these functions in Azure, there are iothub_CreateorUpdate, StreamAnalytics_Create, and Blob_Create, and functions and services for Azure are set by using these commands.

The AWS has functions and services such as AWS IoT, S3, and EC2, the Google Cloud Platform has functions and services such as Compute Engine, Cloud Storage, Cloud Machine Learning Engine, and the Bluemix has functions and services such as IBM Watson, Compute, and Storage.

In the AWS, the EC2 (Amazon Elastic Compute Cloud) is a web service that provides safe, size-changeable computing performance in the cloud. In addition, the IBM Watson is a highly accurate AI for questioning and answering. These services are partial services, and there are a considerable number of services and functions. In addition, there is a possibility that the data can be extracted at a high speed. For this reason, transaction of the database to be used is not ensured so much, but a NoSQL database is desirable.

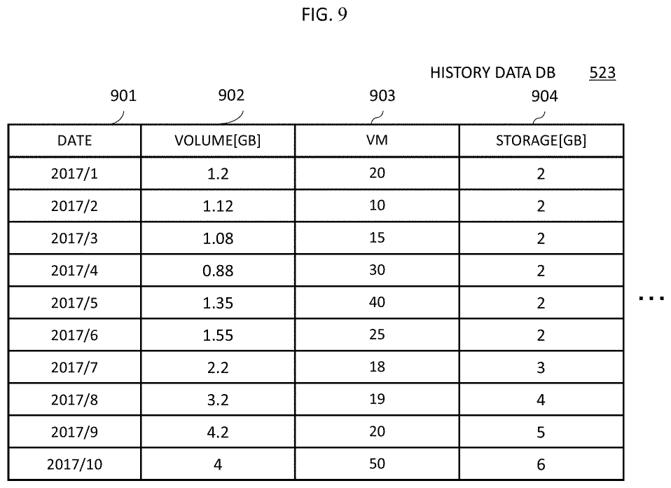

FIG. 9 is a diagram illustrating the history data DB 523 in the present embodiment. The kitting device 107 includes the history data DB 523 and stores the past user requests and the like (data amount, number of VMs, storage capacity, or the like) described in FIG. 7 in the history data DB 523.

Besides, as the data required to construct the system, there are exemplified a CPU usage rate, a memory usage rate, a latency, a network traffic, a processor idle time, a buffer cache amount, a swap amount, the number of abnormal Log messages, the number of times of server accessing, and the like. All of these data are not necessarily required for constructing the system, but these data may be used according to the performance required for the system. These past histories are stored in the database. On the basis of the stored data the cost prediction unit 518 predicts future costs from these past histories by polynomial approximation, and the cloud service selection unit 519 selects the appropriate cloud service according to the lowest price condition in the future. In addition, since this history data DB may extract a large data amount at a high speed, a NoSQL database is desirable as the database to be used.

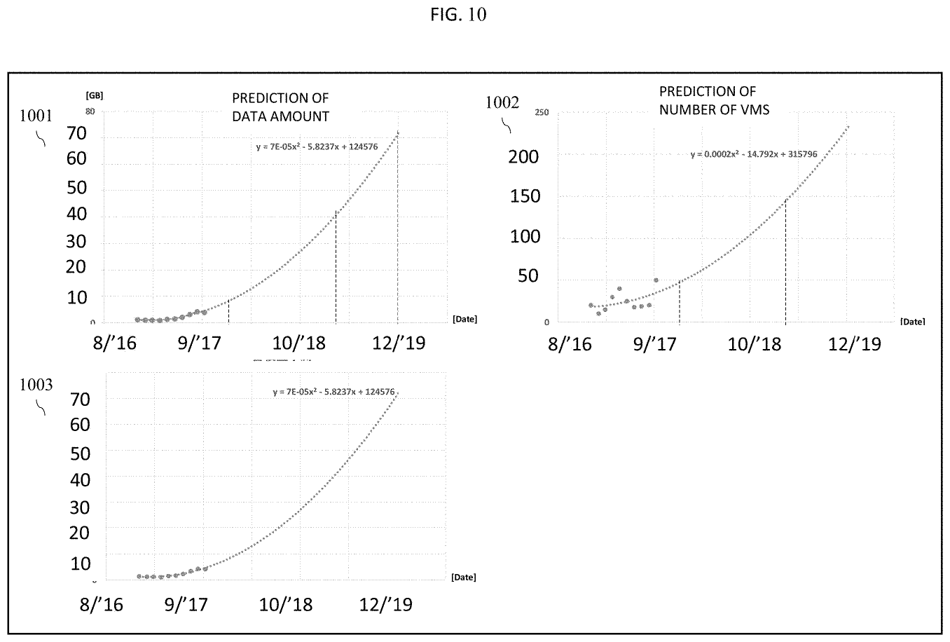

FIG. 10 is a diagram illustrating prediction results obtained from a past user request (data amount 1001, number of VMs 1002, accumulation amount (storage capacity) 1003, or the like) in the present embodiment. The future is predicted from the past data history stored in the history data DB illustrated in FIG. 9. As an example in performing the future prediction, a method of performing polynomial approximation of data and predicting a future value from approximate expression is taken. Such analysis can be easily executed with various tools such as Microsoft Excel, SAS, Stata, SPSS, and the future value can be easily calculated. For example, if polynomial approximation is performed from the data amount illustrated in FIG. 9 with X being the number of days and Y being the data amount, the following mathematical formula can be obtained from FIG. 10.

[Mathematical Formula (1)]

Y=7E−5*X\hat{ }2−5.8237*X+124576 (1)

The future values can be calculated from this mathematical formula.

For example, in FIG. 9, only the data from January to October 2017 is illustrated, but in FIG. 10, the future values up to November 2019 are calculated and predicted from the past history. From FIG. 10, in November 2019, the data amount can be predicted to rise to about 70 GB. Such prediction can be applied not only to the data amount 1001 but also to the number of VMs 1002 and the accumulation amount 1003 in the same manner, and future values thereof can be also predicted from the past history.

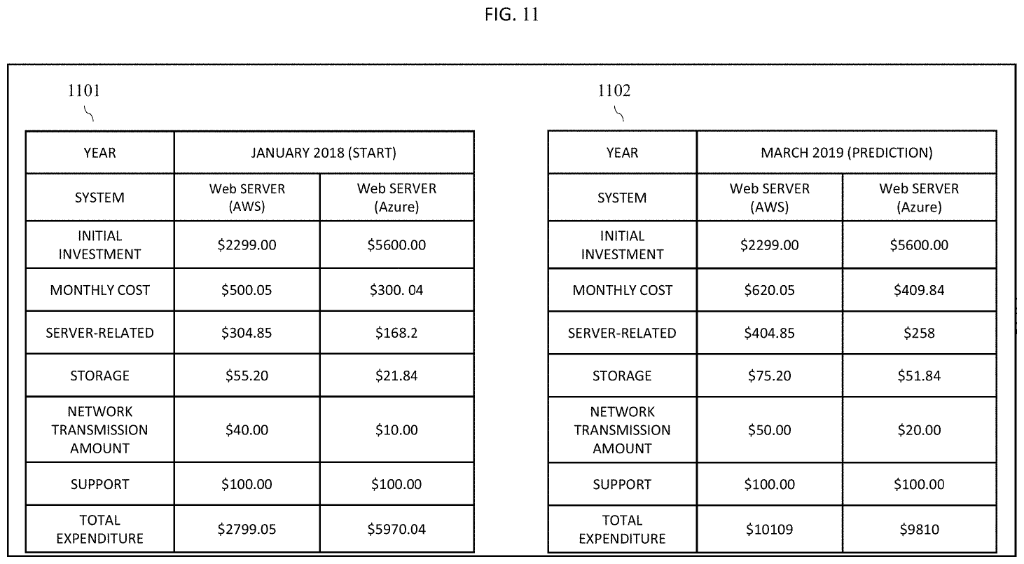

FIG. 11 is a diagram illustrating a future expenditure calculated from a prediction result obtained from a user request (data amount, number of VMs, accumulation amount, or the like) to the cloud service in the present embodiment. In FIG. 10, the expenditure from 2018 to November 2019 can be predicted from the results of the data amount, number of VMs, and the accumulation amount obtained by polynomial approximation until November 2019.

For example, from FIG. 10, in January 2018, the data amount 1001 is about 8 GB, and the number of VMs 1002 for processing the data amount is about 50. According to the AWS price list (not illustrated), the price for this requirement is, for example, about $500 per month. On the other hand, in March 2019 (1102), from FIG. 10, the data amount is about 40 GB, and the number of VMs for processing the data amount is increased to about 150. Therefore, according to the AWS price list, for example, the monthly cost can be predicted to rise to about $620.

Similarly, according to Microsoft's price list (not illustrated), in the Azure, in January 2018, for example, the monthly cost is about $300, and in March 2019, for example, the monthly cost is about $410. According to the reading out from this table, the AWS has a lower initial investment than the Azure but a higher monthly cost than the Azure. Thus, the total expenditure is lower in the AWS in January 2018 but lower in the Azure in March 2019. These values are examples and need to be reliably calculated along the actual price range.

The price illustrated in FIG. 11 is an example, and the Price is constantly updated by the provider of the public cloud service. The present embodiment is configured such that the latest price information is stored in the cloud asset DB 524.

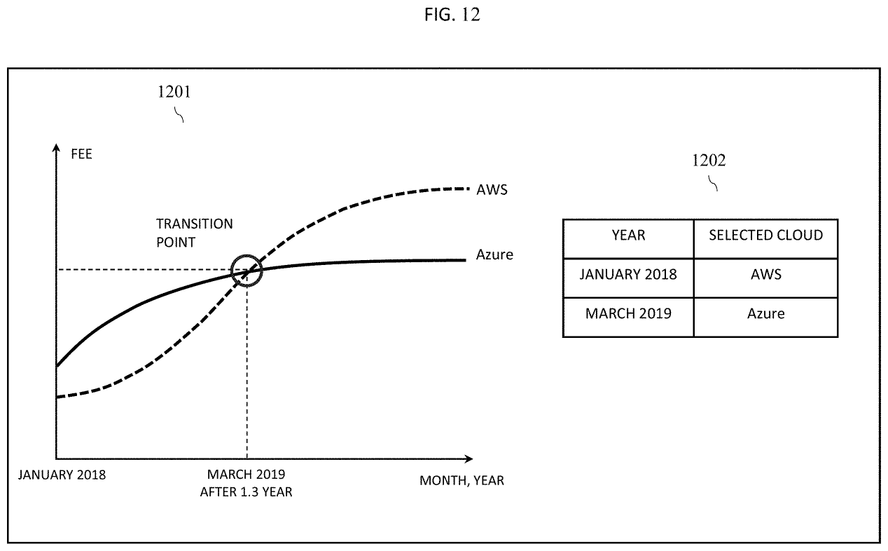

FIG. 12 is a diagram illustrating a trend of the future expenditure calculated from the prediction result obtained from the user request (data amount, number of VMs, accumulation amount (storage capacity), or the like) for the cloud service in the present embodiment. From the above-described table, the AWS has a lower initial investment than the Azure, but the monthly cost of the AWS is higher than that of the Azure. A fee graph (1201) as illustrated in FIG. 12 can be drawn from these fee prediction results.

As can be understood from this graph, the total future expenditure will be higher in the case of the AWS in March 2019. After that, it can be understood that the expenditure in the case of the AWS becomes excessively high in comparison to the case of the Azure. For this reason, switching to the Azure in March 2019 when total expenditure will be high can suppress the expenditure in the future. On the basis of these prediction results (1202), a kitting command is generated so as to switch to the Azure in March 2019.

This is an example, and it is desirable to calculate the exact conversion month by taking into consideration the initial investment. For example, in a case where there is a difference of $3000 in the initial investment amount between the current cloud service and the switching destination cloud service, even in the case of switching, the investment amount increased by $3000 is generated. Therefore, even if $3000 is taken into consideration, it is desirable to make a determination to switch only when it can be determined that it is better to switch the cloud service being used to another cloud service in the future.

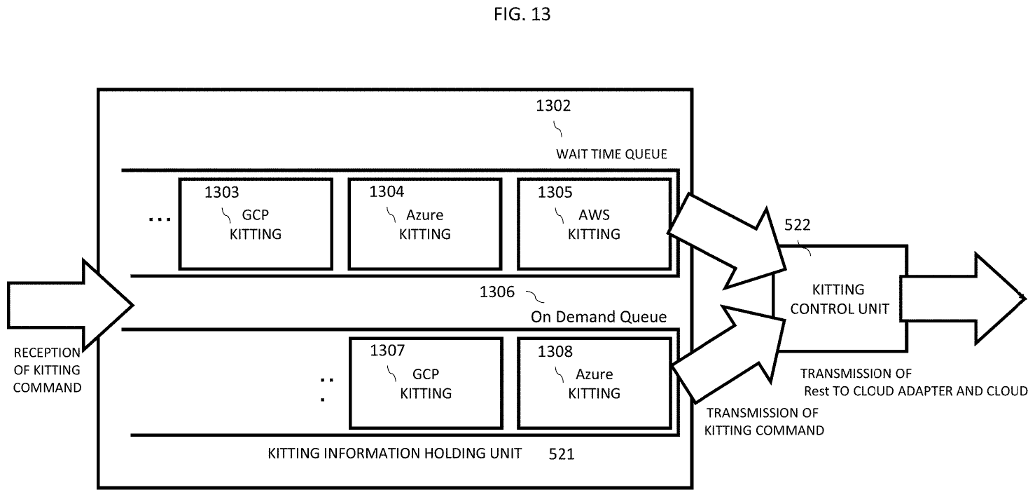

FIG. 13 is a diagram illustrating one function of the kitting information holding unit (521 in FIG. 5) in the present embodiment. The kitting information holding unit 521 includes two queues such as a wait time queue 1302 and an on-demand queue 1306. The wait time queue holds the setting information of the selected cloud service together with the time information to be selected, together with the time information.

The kitting process selection unit 520 generates a kitting command for switching the cloud service by referring to the cloud asset DB 524 and transmits the kitting command to the kitting information holding unit 521. That is, the kitting process selection unit 520 selects one cloud service from the plurality of cloud services selected by the cloud service selection unit 519 on the basis of the cost predicted by the cost prediction unit 518 and generates the setting information of the selected cloud service together with time information to be selected.

The kitting information holding unit 521 performs sorting control of kitting commands by using two queues. Since the cheapest AWS is used initially, a kitting command (1305) of the AWS is stored in the wait time queue. As described above, in order to switch the cloud service to the Azure in March 2019, the command (1304) for performing the setting change to the Azure is stored in the wait time Queue.

In addition, after that, a GCP kitting command (1303) is also stored in order to shift to the GCP. In the wait time queue, a time and a command are set, and when the time is reached, the command is issued from the queue, and the command is transmitted to the kitting control unit.

The kitting command generated by the kitting process selection unit 520 is setting information of one cloud service selected from a plurality of the cloud services. The setting information includes header information and a setting command. The header information includes the information specifying the command type of the wait time queue or the on-demand queue, the execution time of the wait time queue, and the cloud service. The execution time of the wait time queue is time information for selecting one cloud service from a plurality of the cloud services. In addition, the setting command includes the setting information such as parameters specifying the cloud service such as the user request (data amount, number of VMs, accumulation amount (storage capacity), or the like), for example, the information specifying the instance type in the AWS.

In this manner, the wait time queue holds the setting command of the selected cloud service together with the time information to be selected, together with the time information.

If the user inputs parameters for command generation, the parameters are input from the Web browser, or a plurality of instances with various parameters determined in advance are prepared, so that, when the user selects that instance, the setting command can be automatically selected.

The kitting control unit 522 performs kitting for each cloud service on the basis of the kitting command and installs the adapter for each cloud service in the cloud hub of the cloud adapter.

In addition, since an on-demand queue is also provided, even in a case where there is no past history of user requests and setting of the cloud service is immediately performed, if a setting command as setting information is stored in the on-demand queue, the command is immediately transmitted to the kitting control unit to immediately execute various setting changes such as selection and performance change of the cloud service. The setting information stored in the on-demand queue indicates if there is no execution time included in the wait time queue and includes the time information at the time of creating the setting information.

When the immediate switching to the Azure is intended, if a kitting command 1308 which is a setting command of the Azure is stored in the on-demand queue, the setting of the Azure is immediately performed, and thus, the immediate switching to the Azure is achieved. It is possible to immediately switch to the GCP 1307 and other cloud services.

As described above, in the present embodiment, for setting of the switching of the cloud based on the future prediction, a plurality of the kitting commands in the wait time queue can be prepared together with the timing of the cloud service switching. In addition, if the on-demand queue is used, it is possible to respond to sudden changes in price setting by a public cloud provider or changes of user requests to perform analysis of a sensor data by using the public cloud, for example, requests to perform analysis of a large data amount in a short time or requests to store a large data amount at a low cost.

In a case where a new kitting command is set for the on-demand queue according to the user request for the public cloud, the cloud service selection unit 519 selects whether the command of the wait time queue that is set to be executed is invalidated or validated in response to the user request for the public cloud at the time of setting the on-demand queue, and in a case where the command is invalidated, the kitting process selection unit 520 releases the command from the queue.

As described above, according to the present embodiment, it is possible to provide cloud service having best configuration to the user by performing kitting using two types of queues, that is, the wait time queue that stores a plurality of the cloud settings together with the setting timing and the on-demand queues corresponding to changes in assets such as fee and performance of the public cloud and changes in required performance for the system of the user of the public cloud.

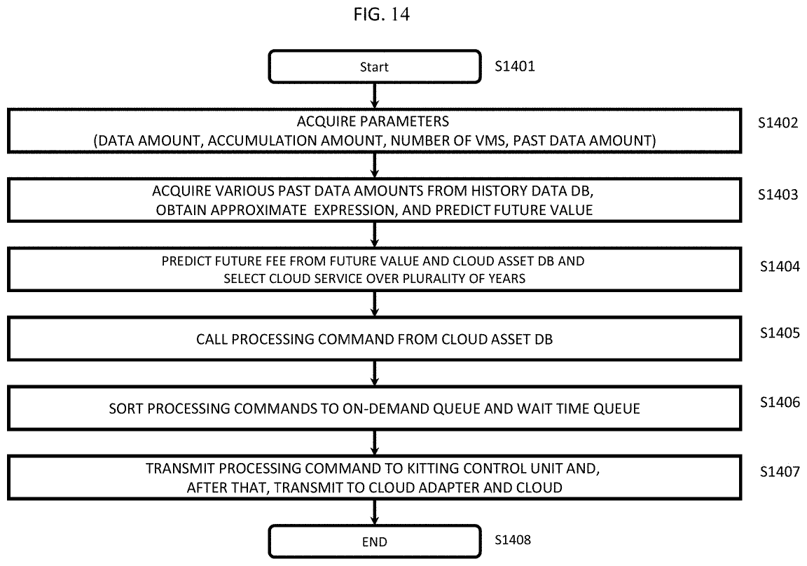

FIG. 14 is a flowchart illustrating a series of operations of the kitting device 107 in the present embodiment. The kitting device 107 starts operations by inputting a parameter from the GUI screen and then pressing an execution button (S1401).

Next, various parameters such as a sensor type, the number of VMs to be used, the number of sensors, a storage capacity ensured for cloud services, and past user requests (data amount, the number of VMs, a storage capacity, or the like) are acquired from the parameters input on the GUI by the parameter acquisition unit 517 via the Node-RED runtime. At this time, the history data DB is also read into the RAM (S1402).

Next, the cost prediction unit 518 calls the past user request from the history data DB, obtains an approximate expression of the data, and predicts a future value from the approximate expression (S1403).

Next, the future value is transmitted to the cloud service selection unit 519. The cloud service selection unit 519 calls the functions and services for each cloud service and the costs corresponding to the functions and services from the cloud asset DB 524 in which the functions and services (assets) that can be used in each cloud service, the costs for those functions and services, and commands required for setting are stored in a Json format, and the like and calculates the costs in the future from the future values of the resources obtained above. A cloud service with the least expenditure over a plurality of years is selected from the results (S1404).

The result of the cloud service to be selected is transmitted to the kitting process selection unit 520. The kitting process selection unit 520 calls a command corresponding to each function and service from the cloud asset DB to perform setting the function and service of the selected cloud service and forms kitting commands (S1405).

The kitting information holding unit 521 sorts the formed kitting commands to the on-demand queue 1306 that requires immediate setting or the wait time queue 1302 that executes setting after a predetermined time has elapsed and stores the kitting commands in the respective queues (S1406).

After that, each queue transmits the command to the kitting control unit 522 at a set time or immediately. The kitting control unit 522 performs automatic setting of the cloud adapter 106 and automatic setting of the cloud (S1407). The kitting device 107 executes a series of these operations, switches the plurality of cloud services over a plurality of years, and performs connection seamlessly without service stoppage.

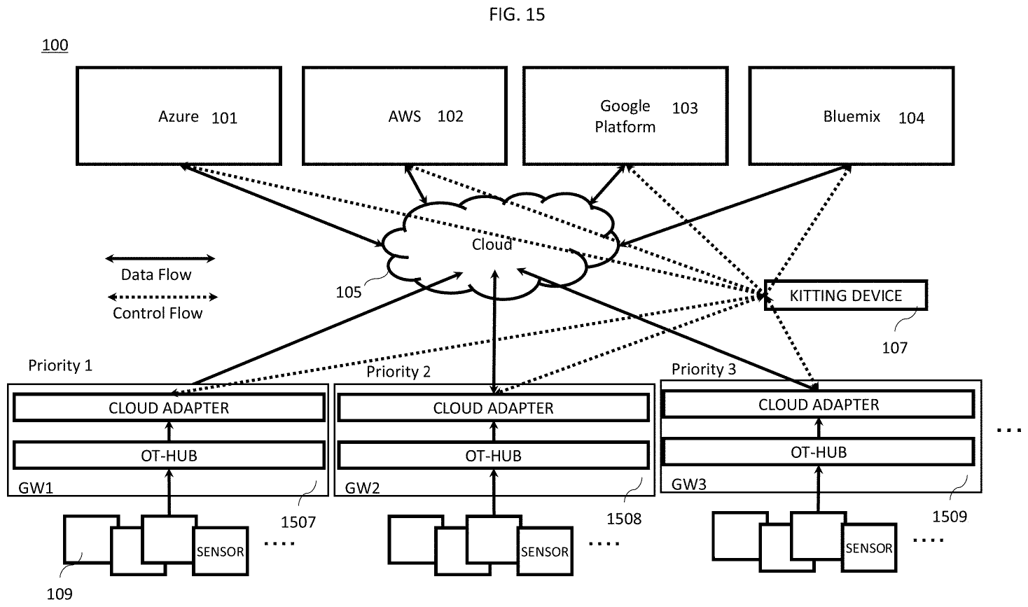

FIG. 15 is a diagram illustrating kitting control on a plurality of the cloud adapters performed by the kitting device 107. In a plurality of the cloud services (101, 102, 103, the 104), the data such as the sensor data is transferred from a plurality of GWs (1507, 1508, and 1509) where a plurality of the sensors are transmitting the data. In order for each GW to seamlessly connect to a plurality of the cloud services while avoiding service stoppage as much as possible, it is necessary to monitor, in real time, the data amount processed by each GW (OT-hub, cloud adapter), that is, the data amount transmitted to each GW when the kitting device 107 performs settings for the cloud adapter 106.

If the setting change is forcibly executed without monitoring, the data amount cannot be grasped, and the Possibility of causing service stoppage is very high. As the number of GWs managed increases, the possibility of causing service stoppage increases. Therefore, in order to avoid unnecessary service stoppage, priority control of the kitting process (the setting of the cloud adapter and the like) is performed according to the data amount in consideration of the data amount received by each GW. The kitting device 107 controls the setting change timing of the relay device and the selected cloud service on the basis of the reception status of the sensor data of the relay device received from the relay device of the cloud adapter 106.

For example, the setting is executed first in ascending order of the data amounts. In addition, the setting change is not performed for the GWs in which the data amount exceeds a certain threshold value. If the setting change is performed in a case where the received data amount of the GW is excessive, there is a possibility that the service stoppage occurs. Therefore, in a case where the data amount is excessive, the setting change is not performed as much as possible to avoid unnecessary service stoppage.

Moreover, the control may be performed according to the importance of the data which is being transmitted. For example, if the information being transmitted is very important and urgent data (for example, in the case of monitoring the situation of the area where the natural disaster occurred in real time), control such as not changing the setting can be also performed.

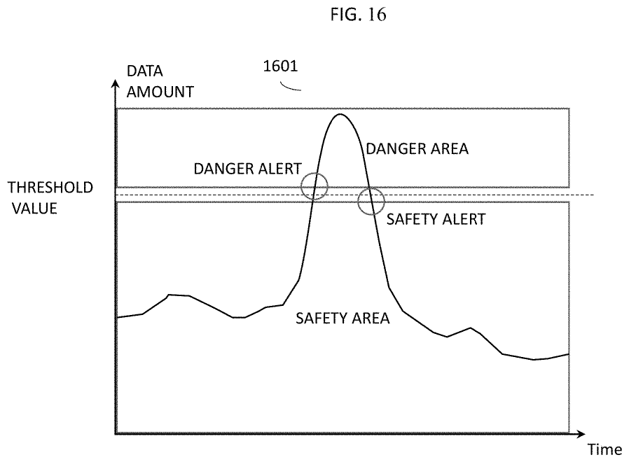

FIG. 16 is a diagram (1601) illustrating a trend of the data amount transmitted from the OT-hub in the present embodiment. Since the cloud adapter has a monitoring function, the received data amount is measured in real time. In this case, a threshold value is defined, and in a case where the data amount exceeds the threshold value, a danger alert is transmitted to the kitting control unit in the kitting device.

In addition, in a case where the data amount is transitioned to the safe area, a safety alert is transmitted to the kitting device. The monitoring 207 of the cloud adapter 106 performs a statistical analysis to calculate the average amount and standard deviation of these data and transmits data of the average data amount and standard deviation data to the kitting device 107. Further, the number of times that the threshold value is exceeded is also counted, and the count number is also stored as a data. Besides, it is conceivable to obtain the slope of the data amount graph, define a threshold value, and count the number of times when the threshold value is exceeded. In addition, in order to detect changes statistically, there are various methods such as a method of obtaining a Mahalanobis distance and a method for obtaining a Euclidean distance from the average data amount.

The kitting device 107 controls the timing of the setting change of the cloud adapter 106 and the selected cloud service on the basis of the alert received from the cloud adapter 106, the average data amount, and the standard deviation.

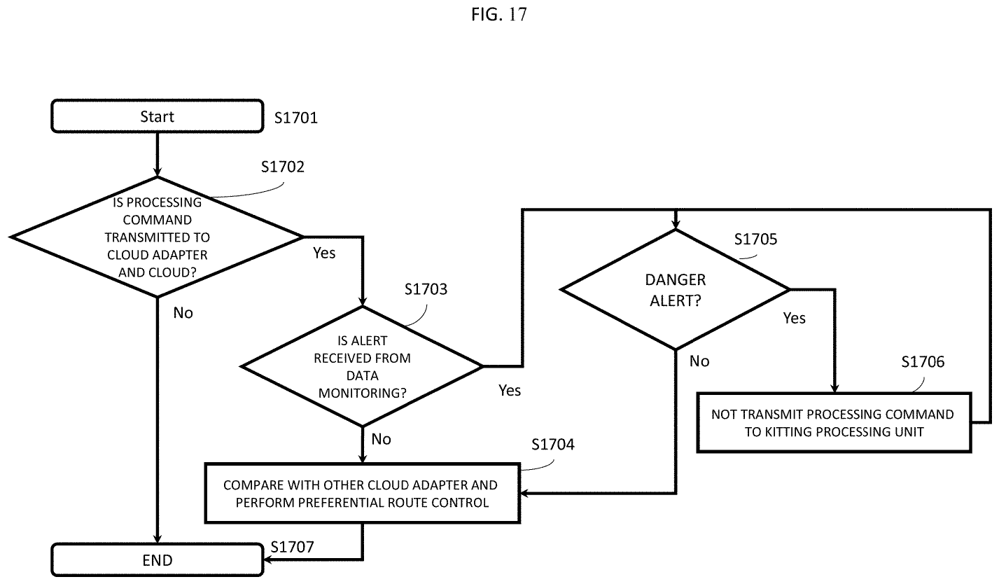

FIG. 17 is a flowchart illustrating a series of operations of the kitting control unit 522 which is one function of the kitting device 107 in the present embodiment. The kitting control unit 522 performs control on the basis of the alert transmitted from the monitoring 207 in the cloud adapter 106.

First, the kitting command is transferred from the kitting information holding unit 521 to the kitting control unit 522 (S1701).

The kitting control unit 522 transmits the transferred kitting command to the cloud adapter 106 or the cloud 101 (S1702). At this time, first, it is checked whether or not the alert transmitted from the monitoring 207 of the cloud adapter 106 is received (S1703).

If an alert is received, it is checked whether or not the alert is a danger alert which is transmitted exceeding the threshold value (S1705). If the alert is a danger alert, the kitting control unit 522 does not transmit a kitting command to the cloud adapter 106 or the cloud 101 (S1706). Alternatively, even if the kitting command is transmitted, the cloud adapter 106 and the cloud 101 prepare for switching. However, the setting of the routing control unit 416 is not changed, the change of the route of the flowing data is not changed (S1706). In a case where the monitoring 207 transmits only the danger alert, step S1702 may be omitted.

After that, the kitting control unit 522 checks the alert again after a certain period of time, and in a case where the reception of the alert that can check that the data amount is safe can be checked, preferential control is performed according to the average data amount included in the alert. (S1704).

In addition, control can be performed by using standard deviation together, and if the standard deviation is large, the probability of occurrence of the burst is high. Therefore, the setting control is performed preferentially from the cloud adapter in which data with a small standard deviation flows. In addition to the standard deviation, the number of times that a certain threshold value is exceeded, that is, the number of times of burst can be used instead of the standard deviation. The threshold value can be obtained from the past average data amount.

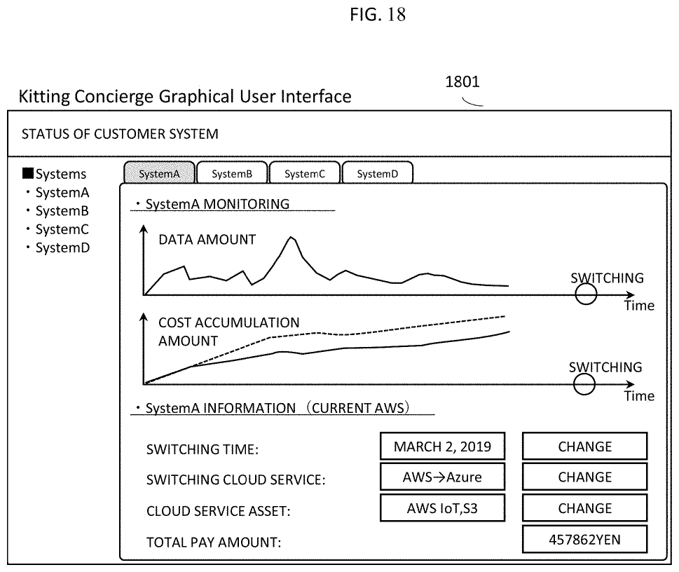

FIG. 18 is a diagram illustrating a GUI (1801) of the kitting device in the present embodiment. The kitting device 107 includes a GUI and can set various items on the GUI in order to respond to customer requests immediately and flexibly. The parameters to be set include a switching date for switching the cloud service, a switching cloud service, a cloud asset to be used, and the like.

In addition, from the GUI, the total expenditure up to now and changes in the data amount currently being transmitted in real time can checked from the screen. In addition, the functions and services of the cloud service to be used can be chanced from the GUI. Such a user interface can be diverted to not only a GUI but also a Web API. In addition, in the GU, setting of a plurality of systems can be performed. The setting parameter of each system can be displayed and set by switching tabs on the GUI.

As described above, according to the present embodiment, fee systems of a plurality of cloud service are held in advance, and comparison between the plurality of services can be performed on the basis of changes in the data amount or the number of Ms handled by the system and the storage capacity required by the system.

For example, in order to predict the fee for the plurality of services in the future, a cloud service with a suppressed fee is selected, and the service is switched to the selected cloud service. Therefore, since setting of necessary commands, installation of a program, and the like is stored together in advance, it is possible to switch to the cloud service that satisfies the user request at a good timing.

In addition, it is possible to respond immediately to sudden changes in price setting by a public cloud operator and sudden changes in request of a public cloud user.

There are two types of queues: the wait time queue that stores the plurality of cloud settings together with the setting timing and the on-demand queue that responds to changes in assets such as fee and performance of the public cloud or changes in the required performance of the system of the public cloud user. Therefore, the cloud system having the best configuration can be provided to the user.

In addition, the service stoppage can be prevented by controlling the timing of switching the cloud service according to the data handled by the relay device.

What is claimed is:

1. A setting device for selecting an appropriate cloud service from a plurality of cloud services on the basis of a user request and performing setting the selected cloud service, the setting device comprising:
a storage device which stores a cost for functions and services for the plurality of cloud services and commands for setting the plurality of cloud services as cloud asset information; and
a processing unit which
predicts a cost to occur in the future on the basis of the cloud asset information stored in the storage device and the user request,
selects one cloud service from the plurality of cloud services on the basis of the predicted cost and generates time information to be selected and setting information including a setting command for the selected cloud service, and
transmits the setting information to a relay device to be set according to the time information.

2. The setting device according to claim 1, further comprising:
a first holding unit that holds a plurality pieces of the setting information of the selected cloud service; and
a second holding unit that holds the setting information for immediately performing setting change of the cloud service.

3. The setting device according to claim 1, wherein the processing unit predicts the cost to occur in the future on the basis of a data amount, the number of VMs, and a storage capacity required for the cloud service as the user request.

4. The setting device according to claim 1, wherein the processing unit predicts the cost to occur in the future on the basis of at least one of a CPU usage rate, a memory usage rate, a latency, a network traffic, a processor idle time, a buffer cache amount, a swap amount, the number of abnormal Log messages, and the number of times of server accessing required for the cloud service in addition to the data amount, the number of VMs, and the storage capacity as the user request.

5. A system having a plurality of sensors, a relay device connected to the plurality of sensors, a plurality of cloud services connected to the relay device, and a setting device for setting connection between the relay device and the plurality of cloud services,
wherein the relay device includes:
a storage device which stores a cost for functions and services for the plurality of cloud services and commands for setting the plurality of cloud services as cloud asset information;
a processing unit which
predicts a cost to occur in the future on the basis of the cloud asset information stored in the storage device and the user request,
selects one cloud service from the plurality of cloud services on the basis of the predicted cost and generates time information to be selected and setting information including a setting command for the selected cloud service, and
transmits the setting information to a relay device to be set according to the time information,
wherein, in a case where a data amount of sensor data received from the plurality of sensors exceeds a threshold value, the relay device transmits an alert to the setting device, and
wherein the setting device controls a setting change timing of the relay device and the selected cloud service on the basis of the alert received from the relay device.

6. The system according to claim 5,
wherein a plurality of the relay devices are arranged,
wherein each of the relay devices transmits the alert to be transmitted in a case where the data amount of the sensor data received from the plurality of sensors exceeds the threshold value and an average data amount of the sensor data received from the plurality of sensors to the setting device, and
wherein the setting device controls a setting change timing of the relay device and the selected cloud service on the basis of the alert and the average data amount.

7. The system according to claim 5,
wherein a plurality of the relay devices are arranged,
wherein each of the relay devices transmits the data amount and a standard deviation of the sensor data received from the plurality of sensors to the setting device, and
wherein the setting device controls a setting change timing of the plurality of relay devices on the basis of the standard deviation.

8. The system according to claim 5,
wherein a plurality of the relay devices are arranged, and
wherein the setting device controls a setting change timing of the relay device and the selected cloud service on the basis of the alert transmitted in a case where the data amount of the sensor data received by the relay device exceeds the threshold value and the number of times when the data amount exceeds the threshold value.

9. The system according to claim 5,
wherein a plurality of the relay devices are arranged,
wherein each of the relay devices transmits an alert to be transmitted in a case where the data amount of the sensor data received from the plurality of sensors exceeds a threshold value, an average data amount of the sensor data received from the plurality of sensors, and a data amount and a standard deviation of the sensor data received from the plurality of sensors to the setting device, and
wherein the setting device controls a setting change timing of the relay device and the selected cloud service on the basis of the alert, the average data amount, and the standard deviation received from the relay device.

10. A setting method for selecting an appropriate cloud service from a plurality of cloud services on the basis of a user request and performing setting the selected cloud service,
wherein a setting device
stores a cost for functions and services for the plurality of cloud services and commands for setting the plurality of cloud services in a storage device as cloud asset information,
predicts a cost to occur in the future on the basis of the cloud asset information stored in the storage device and the user request,
selects one cloud service from the plurality of cloud services on the basis of the predicted cost and generates a plurality of pieces of setting information of the selected cloud service together with time information to be selected,
holds the plurality of pieces of setting information, and
transmits one of the plurality of pieces of setting information to the relay device to be set according to the time information.
